(19) United States
(12) Patent Application Publication
(10) Pub. No.: US 2022/0330578 A1
(43) Pub. Date: Oct. 20, 2022

(54) INFUSIBLE BEVERAGE COMPOSITIONS AND USES THEREOF

(71) Applicant: SAYSO BEVERAGES, INC., New York, NY (US)

(72) Inventors: Chloe M. BERGSON, Brooklyn, NY (US); Alison J. EVANS, Brooklyn, NY (US)

(21) Appl. No.: 17/724,295

(22) Filed: Apr. 19, 2022

Related U.S. Application Data
(60) Provisional application No. 63/176,994, filed on Apr. 20, 2021.

(51) Int. Cl. A23L 2/39; A23L 2/02; A23L 2/60; C12G 3/06

(52) U.S. Cl. CPC A23L 2/39; A23L 2/02; A23L 2/60; C12G 3/06

(57) ABSTRACT

The present disclosure generally relates to infusible beverage compositions and methods of use thereof. In some embodiments, infusible beverage compositions disclosed herein can contain one or more natural food products packaged in a porous material. In some embodiments, infusible beverage compositions disclosed herein can be used to prepare non-alcoholic cocktails and/or alcoholic cocktails.

### CROSS REFERENCE TO RELATED APPLICATION

This application claims the benefit of U.S. Provisional Application No. 63/176,994, filed on Apr. 20, 2021, the disclosure of which is hereby incorporated by reference in its entirety.

### FIELD

The present disclosure generally relates to infusible beverage compositions and methods of use thereof. In some embodiments, infusible beverage compositions disclosed herein can contain one or more natural food products packaged in a porous material. In some embodiments, infusible beverage compositions disclosed herein can be used to prepare non-alcoholic cocktails and/or alcoholic cocktails.

### BACKGROUND

Craft cocktails and mocktails have become increasingly popular but difficult to prepare at home. The difficulty with preparing cocktail and non-alcoholic cocktails at home can arise from lack of ingredients on hand, lack of know-how to combine ingredients in correct proportions or flavors, and the time needed to prepare the beverage. Aids for at-home preparation of cocktails can include mixers and prepared cocktail kits. However, these are not preferable solutions as dry mixers take 24-48 hours to infuse, liquid and syrup mixers are artificial and are perishable, and cocktail kits require time consuming assembling and are perishable. A growing demand for the convenience of at-home drink preparation and the ability to control the amount of alcohol in a cocktail has created a need in the art for compositions that can yield beverages for use in preparing craft cocktails and mocktails in a simple manner in the home of the consumer.

### SUMMARY OF THE INVENTION

The present disclosure herein provides an infusible beverage composition and methods of use thereof. In some embodiments, infusible beverage compositions herein can be used as the base for a cocktail beverage, or “cocktail base.” As used herein, the term “cocktail base” refers to an infusible beverage composition having the base elements of the cocktail without having one or more additional ingredients added before serving.

In an aspect, the present disclosure provides infusible beverage compositions that can comprise at least 85% of composite particles and at least 5% of a dehydrated mixture packaged into a porous material. In some embodiments, composite particles herein can contain one or more powdered natural food products, one or more granulated natural food products, or a combination thereof; and a dehydrated mixture herein can be one or more dehydrated natural food products, wherein a natural food product may be a fruit, a vegetable, a spice, a herb, an animal product, or any combination thereof. In some embodiments, infusible beverage compositions herein can be packaged in a porous material that can be a tea bag.

In some embodiments, infusible beverage compositions herein can comprise composite particles that further comprise one or more sugars, artificial sweeteners, natural sweeteners, or any combination thereof. In some embodiments, infusible beverage compositions herein can comprise composite particles that further comprise one or more sugars, artificial sweeteners, natural sweeteners, or any combination thereof at an amount ranging from less than about 0.5% to less than about 90% by weight of the composite particle. In some aspects, composite particles disclosed herein may comprise one or more sugars, artificial sweeteners, natural sweeteners, or any combination thereof at an amount of about 90%, about 85%, about 80%, about 75%, about 70%, about 65%, about 60%, about 55%, about 50%, about 45%, about 40%, about 35%, about 30%, about 25%, about 20%, about 15%, about 10%, about 5%, about 2%, about 1%, or about 0.5% by weight of the composite particle. In some other aspects, composite particles disclosed herein may not comprise one or more sugars, artificial sweeteners, natural sweeteners, or any combination thereof. In some aspects, composite particles disclosed herein may comprise one or more natural sweeteners. In some other aspects, composite particles disclosed herein may comprise erythritol, allulose, or any combination thereof. In still some other aspects, composite particles disclosed herein may comprise one or more sugars.

In some embodiments, infusible beverage compositions herein can comprise composite particles that may have at least 5% powdered natural food product, at least 5% a granulated natural food product, or any combination thereof. In some embodiments, infusible beverage compositions herein can comprise a dehydrated mixture that may have one or more dried fruit pieces, one or more dried vegetable pieces, or any combination thereof.

In another aspect, the present disclosure provides a beverage comprising at least a cocktail base. In some embodiments, a cocktail base can include any of the infusible beverage compositions herein and at least water. In some embodiments, a beverage herein can further comprise at least one additional liquid, wherein the least one additional liquid can be non-alcoholic liquid (e.g., water, juices, teas, coffees), an alcohol, or any combination thereof. In some aspects, alcohols suitable for use in the compositions herein can be brandy, vodka, gin, rum, tequila, scotch, whiskey, wine, beer, flavored liqueur, pisco, schnapps, absinthe, sake, or any combination thereof. In some embodiments, a beverage herein can have a total amount of alcohol not more than about 80% v/v (160 Proof).

In another aspect, the present disclosure provides methods of preparing alcoholic beverages (e.g., cocktails). The methods of preparing alcoholic beverages herein can include the following steps: (i) placing an infusible beverage compositions herein into water, and (ii) adding at least one alcohol, wherein the alcohol comprises brandy, vodka, gin, rum, tequila, scotch, whiskey, wine, beer, flavored liqueur, pisco, schnapps, absinthe, sake, or any combination thereof. In some aspects, an infusible beverage composition can be removed from the water and alcohol mixture after 1 to 60 minutes. In some aspects, an infusible beverage composition can not be removed from the water and alcohol mixture. In some embodiments, methods of preparing alcoholic beverage (e.g., cocktails) can include placing the infusible beverage compositions herein into cold water, room-temperature water, warm water, hot water, or water at a temperature at or above boiling point.

### BRIEF DESCRIPTION OF THE DRAWINGS

The following drawings form part of the present specification and are included to further demonstrate certain aspects of the present disclosure, which can be better understood by reference to the drawing in combination with the detailed description of specific embodiments presented herein.

FIGS. 1A-1B are representative graphs depicting the particle size distribution of a pre-agglomerated blend (FIG. 1A) of the ingredients for a Ginger Rosemary Mule compared to an agglomerated powder blend (FIG. 1B) of the ingredients.

FIGS. 2A-2B are representative graphs depicting the particle size distribution of a pre-agglomerated blend (FIG. 2A) of the ingredients for a Cardamom Paloma compared to an agglomerated powder blend (FIG. 2B) of the ingredients.

### DETAILED DESCRIPTION

The present disclosure provides infusible beverage compositions and methods of use thereof. In some embodiments, infusible beverage compositions disclosed herein can be used as the base for a cocktail beverage, or “cocktail base.” Non limiting examples of cocktails that any of the compositions herein can be used as a cocktail base to create include: B & B, The Blenheim, Blow my Skull Off, Brandy Alexander, Brandy Manhattan, Brandy Sour (Cyprus), Brandy Sour/Brandy Daisy, Chicago Cocktail, Curacao Punch, Diki-Diki, Four Score, French Connection, Hennchata, Horse's Neck, Incredible Hulk, Jack Rose, Panama, Paradise, Pisco sour, Porto flip, Savoy Affair, Savoy Corpse Reviver, Sazerac, Sidecar, Singapore Sling, Stinger, Tom and Jerry, 20th Century, Alexander, Angel Face, Aviation, Bee's Knees, Bijou, Blackthorn, Bloody Margaret, Bramble, Breakfast martini, Bronx, Casino, Cloister, Clover Club Cocktail, Cooperstown Cocktail, Corpse Reviver #2, Damn the Weather, Derby, Fluffy duck, French 75, Gibson, Gimlet, Gin and tonic, Gin Fizz, Gin pahit, Gin sour, Greyhound, Hanky-Panky, John Collins, The Last Word, Lime Rickey, Long Island Iced Tea, Lorraine, Martini, Mickey Slim, Monkey Gland, My Fair Lady, Negroni, Old Etonian, Queens, Paradise, Pegu, Pimm's Cup, Pink Gin, Pink Lady, Ramos Gin Fizz, Royal Arrival, Salty Dog, Shirley Temple Black, Suffering Bastard, Tom Collins, Tuxedo, Vesper Martini, White Lady/Delilah, Wolfram, Ancient Mariner, Bacardi, Between the Sheets, Blue Hawaii, Brass Monkey, Bumbo, Bushwacker, Caribou Lou, Cobra's Fang, Cojito, Cremat, Cuba Libre, Cuban Sunset, Daiquiri, Dark ‘N’ Stormy, El Presidente, Fish House Punch, Flaming Doctor Pepper, Flaming volcano, Fluffy Critter, Grog, Gunfire, Hot buttered rum, Hurricane, Jagertee, Macuá, Mai Tai, Mojito, Mr. Bali Hai, Painkiller, Piña colada, Planter's Punch, Q.B. Cooler, Royal Bermuda Cocktail, Rum Swizzle, Sumatra Kula, Test Pilot, Ti′ Punch, Tschunk, Yellow Bird, Zombie, Acapulco Cocktail, Tequila Sour, Aperol Sunrise, Astronaut Sunrise, Arizona Biltmore, Bloody Aztec, Baby Stout, Bloody Maria, Brave Bull, Caribe Sour, Dressed Michelada, In Noble Fashion, Chimayó Cocktail, Fresh Cucumber Punch, Brunch Money, Enamorada Sunrise, Florida Sunrise, Island Spice, Juan Collins, Noble-Rita, El Duelo, La Ciudad, La Fortuna, Mexica, Mexican martini, Mexican Mocha, Mojito Blanco, Harlem Mugger, Matador, 19° North, Paloma, Prairie Fire, Sangrita, Sangria Popsicles, Tequila Slammer, Tequila Sunrise, Tequila Sunset, Tommy's Margarita, The Last Punch, Noble Punch, Vampiro, Verde Shots, Zen Collins, Agent Orange, Apple Martini or Appletini, Astro pop, Batida, Bay Breeze, Black Russian, Bloody Mary, BLT cocktail, Bull Shot, Caesar, Caipiroska/Caipivodka, Cape Cod, Chi-Chi, Colombia, Cosmopolitan, Dirty Shirley, Espresso Martini, Fizzy apple cocktail, Flirtini, Gimlet, Glowtini, Godmother, Harvey Wallbanger, Hi-fi, Kamikaze, Kensington Court Special, Kremlin Colonel, Lemon Drop, Link Up, Moscow Mule, Mudslide, Orange Tundra, Paralyzer, Platinum Blonde, Red Lotus, Red Russian, Rose Kennedy Cocktail, Salmiakki Koskenkorva, Salty Dog, Screwdriver, Sea Breeze, Sex on the Beach, Vargtass, Vesper, Vodka Gimlet, Vodka Martini, Kangaroo, Vodka McGovern, Vodka Sunrise, White Russian, Woo Woo, Yorsh, Amber Moon, Blue Blazer, Black Nail, Bobby Burns, Boulevardier, Bourbon Lancer, Brooklyn, Churchill, Farnell, Irish coffee, Horsefeather, Jungle Juice, Lynchburg Lemonade, Manhattan, Mint Julep, Missouri Mule, Nixon, Old Fashioned, Old Pal, Rob Roy, Rusty Nail, Three Wise Men, Toronto, Vieux Carré, Ward 8, Whisky Mac, Whiskey sour, gua de Valencia, Black Velvet, Death in the Afternoon, Prince of Wales, and Sangria.

### I. Infusible Beverage Compositions

The present disclosure provides for infusible beverage compositions that may comprise a formulation of various components including, but not limited to sugars, natural sweeteners, artificial sweeteners, fruits, fruit juices, vegetables, vegetable juices, herbs, spices, an animal product, and the like. In some embodiments, instant solid beverages disclosed herein may include composite particles. As used herein, “composite particles” refer to particles fabricated with two or more components. In some embodiments, instant solid beverages disclosed herein may include a dehydrated mixture.

### (a) Composite Particles

Infusible beverage compositions herein may include composite particles formed from one or more powdered ingredients and/or one or more granulated ingredients. Powdered ingredients and granulated ingredients may be prepared by any method known to those skilled in the art, including, but not limited to concentrating and drying the ingredients and/or pulverizing the ingredients. Composite particles disclosed herein may be prepared by any method known to those skilled in the art that provides even homogenous even or heterogeneous mixtures of the ingredients disclosed herein. These can methods include, but are not limited to, dry blending, spray drying, agglomeration, wet granulation, compaction, roller compaction crystallization, co-crystallization, and the like. In some embodiments, an infusible beverage composition herein can comprise one or more types of composite particles. One or more types of composite particles can refer to the one or more powdered ingredients and/or one or more granulated ingredients used to form the composite particles.

In some embodiments, an infusible beverage composition disclosed herein can comprise one or more composite particles formed by agglomeration. As used herein, “agglomeration” is the process of assembling native particles to form bigger agglomerates. The process of agglomerating can be described as taking “raw material” or “feed particles” and growing these particles into increasingly larger particles, i.e., “growing agglomerates.” Agglomerates (i.e., composite particles formed by agglomeration) of the present disclosure can be formed from native particles of the same substance or agglomerated particles formed from native particles of different substances.

In some embodiments, an infusible beverage composition herein can comprise one or more composite particles formed by granulation. The granulation methods herein may be conducted by either a dry method or a wet method. For obtaining a composite particle size suited for dissolution in water or other drinking mediums (e.g., alcohol), a wet granulation method that granulates by using the adhesive force of water or a binder can be preferred. Non-limiting examples of preferred granulation methods include spray-drying granulation, freeze-drying granulation, fluidized bed granulation, and tumbling granulation. Spray-drying is a drying method that sprays a liquid material into a counter-current or parallel air flow to obtain spherical particles by transfer of heat and the material between liquid droplets and the air flow. Spray-drying is simple in steps, and therefore, is suited for continuous operation, mass production and quality control. In freeze-drying, a liquid material is frozen at a low temperature, and subsequent to grinding, a small quality of heat is added under vacuum (about 4.6 Torr or lower). At this time, ice is not converted into water but is allowed to sublimate as is, so that only composite particles are left. The resulting composite particles obtained have not been exposed to heat of high temperature unlike spray drying, and therefore, have a merit that the flavor and taste are hardly impaired. In fluidized bed granulation, continuous motion of individual powdered ingredients and granulated ingredients is ensured to fluidize the mixture into a sufficiently spread state. Then, a binder solution is sprayed into the fluidized bed and a heated air flow is caused to pass through the fluidized bed, so that the composite particles are dried at the same time. Tumbling granulation is a method that conducts granulation by feeding a powder and also adding an appropriate amount of a liquid binder into a cylindrical vessel tilted at from about 40° to about 50° and rotating at from about 10 to about 30 rpm. The ingredients are allowed to grow into particles while being tumbled, so that a granulated product having a somewhat broad particle size distribution is obtained. Tumbling granulation may additionally require a drying step, because water may remain in some instances. In some embodiments, granulation methods disclosed herein can be conducted by using two or more granulation methods in combination.

In some embodiments, an infusible beverage composition herein can comprise one or more composite particles formed by compacting. Non-limiting examples of compacting techniques suitable for use herein include roller compaction, tableting, slugging, ram extrusion, plunger pressing, roller briquetting, reciprocating piston processing, die pressing and pelleting. Those of ordinary skill in the art will appreciate that the shape and appearance of the compacts will vary depending upon the shape and surface characteristics of the equipment used in the compacting step. Accordingly, the compacts may appear smooth, corrugated, fluted, or pillow-pocketed, or the like. In addition, the actual size and characteristics of the compacts will depend upon the type of equipment and operation parameters employed during compaction. In some embodiments, composite particles disclosed herein may be formed by using a roller compactor. A conventional roller compaction apparatus usually includes a hopper for feeding the one or more powdered ingredients and/or one or more granulated ingredients to be compacted and a pair of counter-rotating rolls, either or both of which are fixed onto their axes with one roll optionally slightly moveable. In some embodiments, that one or more powdered ingredients and/or one or more granulated ingredients may be fed to the apparatus through the hopper by gravity or a force-feed screw. The actual size of the resulting compacts will depend upon the width of the roll and scale of the equipment used. In addition, the characteristics of the compacts, such as hardness, density, and thickness will depend on factors such as pressure, roll speed, feed rate, and feed screw amps employed during the compaction process. In some embodiments, the one or more powdered ingredients and/or one or more granulated ingredients may be deaerated prior to the step of compacting. Deaeration may be accomplished through any known means, non-limiting examples of which include roller speed, screw feeding, vacuum deaeration, and combinations thereof.

In some embodiments, composite particles disclosed herein may contain a native sugar particle processed with one or more powdered ingredients and/or granulated ingredients. As used herein, the term “sugar” is intended to mean any sucrose or sweet tasting matter or combination of matter. Besides sucrose, other exemplary sugars include dextrose, glucose, fructose, levulose, lactose, maltose, cellobiose, and sugar substitutes. Sugar substitutes may include artificial sweeteners, natural sweeteners, or a combination thereof. In some embodiments, composite particles disclosed herein may contain one or more artificial sweeteners. Non-limiting examples of artificial sweeteners include aspartame, saccharin, acesulfame-K, cyclamate, sucralose, alitame, and the like. In some embodiments, composite particles disclosed herein may contain one or more natural sweeteners. Natural sweeteners include, but are not limited to, stevia, erythritol, monk fruit, acesulfame potassium, allulose, xylitol, yacon, and the like. In some aspects, composite particles disclosed herein may contain erythritol, allulose, or a combination thereof. Erythritol is a sugar alcohol found naturally in certain fruits and a processed version is available in powdered form. It contains about 6% of the calories in an equal amount of sugar with 70% of the sweetness. Ingestion of erythritol does not spike blood sugar or insulin levels or affect levels of blood fats like cholesterol or triglycerides. Allulose is a low-calorie sweetener that has 70% of the sweetness of sugar. People with diabetes and obesity can benefit from this sugar substitute because it is low in calories and has little effect on blood sugar.

As used herein, the term “sucrose” refers to crystalline dextrorotatory disaccharide sugar, C₁₂H₂₂O₁₁, which occurs naturally in many plants like, for example, sugarcane and sugarbeet. Additionally, sucrose does not reduce Fehling's solution to produce a color precipitate, is stable in air, is hydrophilic and capable of absorbing moisture, and may be hydrolyzed to glucose and fructose by acid as well as invertase. In granular form, sucrose is encompassed by the term granular food and may include, for example, raw sugar, brown sugar, confectioner's sugar, refined sugar, white refined sugar, pure cane sugar, and combinations thereof. The sucrose may be at least about 96% pure, preferably at least about 98% pure, and most preferably from about 99% to about 99.9% or even about 99.99% pure and may contain from about 0.01% to 0.4% pre-shipping moisture, from about 0% to about 1% reducing sugars, and from about 0% to about 0.5% ash.

In some embodiments, composite particles disclosed herein can be about 0.01% to about 99%, about 0.05% to about 95%, or about 0.1% to about 80% sugar, artificial sweetener, natural sweetener, or a combination thereof by weight. In some embodiments, composite particles disclosed herein can have less than about 100%, less than about 95%, less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, less than about 10%, less than about 5%, less than about 2.5%, less than about 1%, or less than about 0.5% sugar, artificial sweetener, natural sweetener, or a combination thereof by weight. In some embodiments, composite particles disclosed herein may contain one or more powdered ingredients and/or granulated ingredients in the absence of a native sugar particle, artificial sweetener, natural sweetener, or any combination thereof.

In some embodiments, one or more powdered ingredients and/or granulated ingredients of the composite particles disclosed herein can be a dry powdered food product. Methods of preparing a dry powdered food product are known in the art and are suitable for use herein, provided optimization of the method if needed. In some embodiments, one or more granulated ingredients of the composite particles disclosed herein can be a dry granulated food product. Methods of preparing a dry granulated food product are known in the art and are suitable for use herein, provided optimization of the method if needed. In some embodiments, composite particles disclosed herein can be about 5% to about 99%, about 10% to about 95%, or about 20% to about 80% total powdered ingredients and/or granulated ingredients by weight.

In some embodiments, powdered ingredients and/or granulated ingredients herein can be prepared from any fruit that is suitable for human consumption. Non-limiting examples can be acerola, apple, apricot, bilberry, blackberry, blueberry, cherry, citron, clementine, cloudberry, cranberry, date, dragonfruit, elderberry, fig, gooseberry, granadilla, grape, grapefruit, greengage, guava, kiwi fruit, kumquat, lemon, lime, loganberry, lychee, mandarin, mango, medlar, melon, mulberry, orange, papaya, passion fruit, paw paw, peach, pear, physalis, pineapple, plum, pomegranate, quince, raspberry, strawberry, tangerine, watermelon, and the like.

In some embodiments, powdered ingredients and/or granulated ingredients herein can be prepared from any vegetable that is suitable for human consumption. Non-limiting examples can be artichoke, asparagus, legumes (e.g., beans, lentils, peas), broccoli, brussel sprouts, cabbage, celery, endive, greens (e.g., bok choy, kale, spinach), lettuce, mushrooms, onions (e.g., chives, garlic, shallot), peppers (e.g., bell pepper, chili pepper, jalapeno, habanero, paprika, tabasco pepper, cayenne pepper), rhubarb, carrots, ginger, parsnip, rutabaga, radish (e.g., wasabi, horseradish), potato, sweet potato, yam, squashes, tomatoes, and the like.

In some embodiments, one or more powdered ingredients and/or granulated ingredients of the composite particles disclosed herein can be one or more fruit-based powdered ingredients and/or granulated ingredients, one or more vegetable-based powdered ingredients and/or granulated ingredients, or a combination of one or more fruit-based powdered ingredients and/or granulated ingredients and one or more vegetable-based powdered ingredients and/or granulated ingredients. In some embodiments, composite particles disclosed herein may be formed with a sugar and/or one or more powdered ingredients and/or granulated ingredients. In some embodiments, composite particles disclosed herein may be formed with one or more powdered ingredients and/or granulated ingredients without a sugar. In some embodiments, composite particles disclosed herein may be formed with one or more powdered ingredients and/or granulated ingredients and an artificial sweetener, a natural sweetener, or a combination thereof. In some aspects, composite particles disclosed herein may be formed with one or more powdered ingredients and/or granulated ingredients and at least one natural sweetener in the absence of a sugar.

In some embodiments, composite particles disclosed herein can be homogenous in size. In some embodiments, composite particles disclosed herein can be heterogeneous in size. In some embodiments, composite particles herein can be about 100 μm to about 1.5 mm in diameter, about 200 μm to about 1.25 mm in diameter, or about 500 μm to about 1.0 mm in diameter. In some embodiments, composite particles disclosed herein can be about 100 μm to about 1.5 mm in diameter, about 200 μm to about 1.25 mm in diameter, or about 500 μm to about 1.0 mm in diameter. In some embodiments, composite particles disclosed herein can be about 100 μm in diameter, about 150 μm in diameter, about 200 μm in diameter, about 250 μm in diameter, about 300 μm in diameter, about 350 μm in diameter, about 400 μm in diameter, about 450 μm in diameter, about 500 μm in diameter, about 550 μm in diameter, about 600 μm in diameter, about 650 μm in diameter, or about 700 μm in diameter. In some embodiments, composite particles disclosed herein can have a diameter suitable for not escaping a mesh packet comprising the infusible beverage compositions disclosed herein. In some embodiments, composite particles disclosed herein can have a diameter larger than about 707 μm, about 595 μm, about 500 μm, about 420 μm, about 354 μm, about 297 μm, or about 250 μm.

In some embodiments, composite particles disclosed herein can have a bulk density ranging from about 0.1 g/cc to about 1.5 g/cc, from about 0.25 g/cc to about 1.25 g/cc, or from about 0.5 g/cc to about 1.0 g/cc. In some embodiments, composite particles disclosed herein can have a bulk density of about 0.10 g/cc, about 0.15 g/cc, about 0.20 g/cc, about 0.25 g/cc, about 0.30 g/cc, about 0.35 g/cc, about 0.40 g/cc, about 0.45 g/cc, about 0.50 g/cc, about 0.55 g/cc, about 0.60 g/cc, about 0.65 g/cc, about 0.70 g/cc, about 0.75 g/cc, about 0.80 g/cc, about 0.85 g/cc, about 0.90 g/cc, about 0.95 g/cc, about 1.0 g/cc, about 1.15 g/cc, about 1.20 g/cc, about 1.25 g/cc, about 1.30 g/cc, about 1.35 g/cc, about 1.40 g/cc, about 1.45 g/cc, or about 1.50 g/cc.

In some embodiments, composite particles disclosed herein can have a moisture level below at least about 2.5%, at least about 2.25%, or at least about 2.0% relative to total weight. One of skill in the art can appreciate that moisture level of a material can be measured multiple ways. As a non-limiting example, moisture level can be measured by determining the wet basis moisture content which is described by the percentage equivalent of the ratio of the weight of water to the total weight of the material (e.g., a composite particle). In some embodiments, composite particles disclosed herein can have a moisture level ranging from about 0.05% to about 2.0%, about 0.1% to about 1.95%, or about 0.15% to about 1.9% relative to total weight. In some embodiments, composite particles disclosed herein can have a moisture level of about 0.05%, about 0.10%, about 0.15%, about 0.20% about 0.25%, about 0.30%, about 0.35%, about 0.40% about 0.45%, about 0.50%, about 0.55%, about 0.60% about 0.65%, about 0.70%, about 0.75%, about 0.80% about 0.85%, about 0.90%, about 0.95%, about 1.0%, about 1.10%, about 1.15%, about 1.20% about 1.25%, about 1.30%, about 1.35%, about 1.40% about 1.45%, about 1.50%, about 1.55%, about 1.60% about 1.65%, about 1.70%, about 1.75%, about 1.80% about 1.85%, about 1.90%, about 1.55%, or about 2.0% relative to total weight.

### (b) Dehydrated Mixtures

In some embodiments, an infusible beverage composition herein can comprise a dehydrated mixture. In some embodiments, a dehydrated mixture herein can have one or more dehydrated natural food products. Methods of preparing dehydrated natural food products are known in the art and are suitable for use herein, provided optimization of the method if needed herein. In some embodiments, a dehydrated mixture herein can be prepared from any fruit that is suitable for human consumption. In some embodiments, a dehydrated mixture herein can be prepared from any vegetable that is suitable for human consumption.

In some embodiments, a dehydrated mixture herein can comprise one or more dried fruit and/or vegetable pieces. In some aspects, dried fruit and/or vegetable pieces for use herein can have a moisture content of less than 30%, preferably the moisture content is from 0.1 to 10%. In some aspects, dried fruit and/or vegetable pieces for use herein can be substantially insoluble in an aqueous liquid such as water (i.e., the dried fruit and/or vegetable pieces will not dissolve when steeped or soaked in an aqueous liquid, although they typically release certain water-soluble substances into the liquid, e.g., flavor and/or aroma molecules). In some embodiments, a dehydrated mixture herein can comprise one or more dried fruit and/or vegetable pieces that are about 0.1 mm to about 8 mm, about 0.2 mm to about 6 mm, or about 0.3 mm to about 4 mm in diameter.

In some embodiments, a dehydrated mixture herein can comprise one or more dried herbs and/or spices. Non-limiting examples of herbs and/or spices suitable for use in a dehydrated mixture herein can be Ajwain, carom seeds (Trachyspermum ammi), Akudjura (Solanum centrale), Alexanders (BullaSmyrnium olusatrum), Alkanet (Alkanna tinctoria), for red color, Alligator pepper, mbongo spice (mbongochobi), hepper pepper (Aframomum danielli, A. citratum, A. exscapum), Allspice (Pimenta dioica), Angelica (Angelica archangelica), Anise (Pimpinella anisum), Anise Hyssop (Agastache foeniculum), Aniseed myrtle (Syzygium anisatum), Annatto (Bixa orellana), Apple mint (Mentha suaveolens, Menthaxrotundifolia and Menthaxvillosa), Artemisia (Artemisia spp.), Asafoetida (Ferula asafoetida), Asarabacca (Asarum europaeum), Avens (Geum urbanum), Avocado leaf (Peresea americana), Barberry (Berberis vulgaris and other Berberis spp.), Basil, sweet (Ocimum basilicum), Basil, lemon (Ocimumx citriodorum), Basil, Thai (O. basilicum var. thyrsiflora), Basil, Holy (Ocimum tenuiflorum), Bay leaf (Laurus nobilis) Bay leaf, Indian, tejpat, malabathrum, Bcc balm (Monarda didyma), Boldo (Peumus boldus), Borage (Borago officinalis), Black cardamom (Amomum subulatum, Amomum costatum), Black mustard (Brassica nigra), Blue fenugreek, blue melilot (Trigonella caerulea), Brown mustard (Brassica juncea), Caraway (Carum carvi), Cardamom (Elettaria cardamomum), Catnip (Nepeta cataria), Cassia (Cinnamomum aromaticum), Cayenne pepper (Capsicum annuum), Celery leaf (Apiumi graveolens), Celery seed (Apiumi graveolens), Chervil (Anthriscus cerefolium), Chicory (Cichorium intybus), Chili pepper (Capsicum spp.), Chives (Allium schoenoprasum), Cinchona Bark Yellow (Cinchona Spp.), Cicely, sweet cicely (Myrrhis odorata), Cilantro, coriander greens, coriander herb (Coriandrum sativum), Cinnamon, Indonesian (Cinnamomum burmannii, Cassia vera), Cinnamon, Saigon or Vietnamese (Cinnamomum loureiroi), Cinnamon, true or Ceylon (Cinnamomum verum, C. zeylanicum), Cinnamon, white (Canella winterana), Cinnamon myrtle (Blackhousia myrtifolia), Clary, Clary sage (Salvia sclarea), Clove (Syzygium aromaticum), Coriander seed (Coriandrum sativum), Costmary (Tanacetum balsamita), Cuban oregano (Plectranthus amboinicus), Cubeb pepper (Piper cubeba), Cudweed (Gnaphalium spp.), Culantro, culangot, long coriander (Eryngium foetidum), Cumin (Cuminum cyminum), Curry leaf (Murraya koenigii), Curry plant (Helichlysum italicum), Dill seed (Anethum graveolens), Dill herb or weed (Anethum graveolens), Elderflower (Sambucus spp.), Epazote (Dysphonia ambrosioides), Fennel (Foeniculum vulgare), Fenugreek (Triganella foenum-graecum), File powder, gumbo filé (Sassafras albidum), Fingerroot, krachai, temu kuntji (Boesenbergia rotunda), Galangal, greater (Alpinia galanga), Galangal, lesser (Alpinia officinarum), Galingale (Cyperus spp.), Garlic chives (Allium tuberosum), Ginger (Zingiber officinale), Ginger, torch, bunga siantan (Etlingera elatior), Golpar, Persian hogweed (Heracleum persicum), Gentian Root (Gentiana Lutea L.), Grains of paradise (Aframomum melegueta), Grains of Selim, Kani pepper (Xylopia aethiopica), Horseradish (Armoracia rusticana), Houttuynia cordata, Huacatay, Mexican marigold, mint marigold (Tagetes minuta), Hyssop (Hyssopus officinalis), Indonesian bay leaf, daun salam (Syzygium polyanthum), Jasmine flowers (Jasminum spp.), Jimbu (Allium hypsistum), Juniper berry (Juniperus communis), Kaffir lime leaves, Makrud lime leaves (Citrus hystrix), Kala zeera (or kala jira), black cumin (Bunium persicum), Kawakawa seeds (Macropiper excelsum), Kencur, galangal, kenttur (Kaempferia galanga), Keluak, kluwctk, kepayang (Pangium edule), Kinh gioi, Vietnamese balm (Elsholtzia ciliara), Kokam seed (Garcinia indica), Korarima, Ethiopian cardamom, false cardamom (Aframomum corrorima), Koseret leaves (Lippia adoensis), Lavender (Lavandula spp.), Lemon balm (Melissa officinalis), Lemongrass (Cymbopogon citratus, C. flexuosus, and other Cymbopogon spp.), Lemon ironbark (Eucalyptus staigeriana), Lemon myrtle (Backhousia citriodora), Lemon verbena (Lippia citriodora), Leptotes bicolor, Lesser calamine (Calamintha nepeta), nipitella, nepitella, Licorice, liquorice (Glycyrrhiza glabra), Lime flower, linden flower (Tilia spp.), Lovage (Levisticum officinals), Mace (Myristica fragrans), Mahlab, St. Lucie cherry (Prunus mahaleb), Marjoram (Origanum majorana), Mastic (Pistacia lentiscus), Mint (Mentha spp.), Mountain horopito (Pseudowintera colorata) ‘Pepper-plant’, Musk mallow, abelmosk (Abelmoschus moschatus), Mustard, black, mustard plant, mustard seed (Brassica nigra), Mustard, brown, mustard plant, mustard seed (Brassica juncea), Mustard, white, mustard plant, mustard seed (Sinapis alba), Nigella, kalonji, black caraway, black onion seed (Nigella sativa), Nj angsa, dj ansang (Ricinodendron heudelotii), Nutmeg (Myristica fragrans), Olida (Eucalyptus olida), Oregano (Origanum vulgare, O. heracleoticum, and other species) Orris root (Iris germanica, I. florentina, I. pallida), Pandan flower, kewra (Pandanus odoratissimus), Pandan leaf, screwpine (Pandanus amaryllifolius) Paprika (Capsicum annuum), Paracress (Spilanthes acmella, Soleracea) (Brazil) Parsley (Petroselinum crispum), Pepper: black, white, and green (Piper nigrum) Pepper, Dorrigo, Pepper, long (Piper longum) Pepper, mountain, Cornish pepper leaf (Tasmannia ianceolata), Peppermint (Mentha piperata), Peppermint gum leaf (Eucalyptus dives), Perilla, shiso (Perilla spp.), Peruvian pepper (Schinus molle), Brazilian pepper or Pink pepper (Schinus terebinthifolius), Quassia (Quassia amara), Rice paddy herb (Limnophila aromatic), Rosemary (Rosmarinus officinalis), Rue (Ruta graveolens) Safflower (Carthamus tinctorius), Saffron (Crocus sativus), Sage (Salvia officinalis) Saigon cinnamon (Cinnamomum loureiroi), Salad burnet (Sanguisorba minor) Salep (Orchis mascula), Sassafras (Sassafras albidum), Savory, summer (Satureja hortensis), Savory, winter (Satureja montana), Silphium, silphion, laser, laserpicium, lasarpicium, Shiso (Perilla frutescens) Sorrel (Rumex acetosa), Sorrel, sheep (Rumex acetosella), Spearmint (Mentha spicata) Spikenard (Nardostachys grandiflora or N. jatamansi), Star anise (Illicium verum) Sumac (Rhus coriaria), Sweet woodruff (Galium odoratism), Szechuan pepper, Sichuan pepper (Zanthoxylum piperitum), Tarragon (Artemisia dracunculus), Thyme (Thymus vulgaris), Thyme, lemon (Thymusxcitriodorus), Turmeric (Curcuma longa), Vanilla (Vanilla planifolia), Vietnamese cinnamon (Cinnamomum loureiroi) Vietnamese coriander (Persicaria odorata), Voatsiperifery (Piper borbonense), Wasabi (Wasabia japonica), Water-pepper, smartweed (Polygonum hydropiper) Watercress (Rorippa nasturtium-aquatica), Wattleseed (from about 120 spp. of Australian Acacia), White mustard (Sinapis alba), Wild thyme (Thymus serpyllum) Willow herb (Epilobium parviflorum), Wintergreen (Gaultheria procumbens) Wood avens, herb bennet (Geum urbanum), Woodruff (Gallium odoratum) Wormwood, absinthe (Artemisia absinthium, Yellow mustard (Brassica hirta=Sinapis alba), Za'atar (herbs from the genera Origanum, Calamintha, Thymus, and Satureja), Zedoary (Curcuma zedoaria), and the like.

In some embodiments, a dehydrated mixture herein can comprise one or more dried animal products. As used herein, an “animal product” can be animal protein or molecules thereof and/or a protein derived from an animal (e.g., milk, eggs). Non-limiting examples of sources for animal products for use herein can include honey, chicken, turkey, cow, lamb, goat, pig, fish, and the like. In some aspects, an animal product for use herein can be substituted with a non-animal product having the same animal product-based properties (e.g., taste, mouthfeel, aroma). Non-limiting examples can include plant-based meats, non-dairy products, and plant-based egg proteins.

In some embodiments, a dehydrated mixture herein can comprise one or more dried fruit and/or fruit pieces, one or more dried vegetable and/or vegetable pieces, one or more dried herbs, one or more dried spices, one or more dried animal products, or any combination thereof.

In certain embodiments, an infusible beverage composition herein may comprise a combination of any of the composite particles disclosed herein and any of the dehydrated mixtures disclosed herein. In some embodiments, an infusible beverage composition herein can have a ratio of total composite particles to total dehydrated mixture of 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 10:1, or 20:1. In some examples, an infusible beverage composition herein can have a ratio of total composite particles to total dehydrated mixture of about 1:5, about 1:10, or about 1:20. In some embodiments, an infusible beverage composition herein can have about 80% to about 100% (e.g., about 80%, 85%, 90%, 95%, 100%) total composite particles by weight. In some embodiments, an infusible beverage composition herein can have about 0% to about 20% (e.g., about 0%, 5%, 10%, 15%, 20%) total dehydrated mixture by weight. In some embodiments, an infusible beverage composition herein can have about 80% to about 100% (e.g., about 80%, 85%, 90%, 95%, 100%) total composite particles and about 0% to about 20% (e.g., about 0%, 5%, 10%, 15%, 20%) total dehydrated mixture by weight.

In some embodiments, an infusible beverage composition herein can comprise about 0.01 grams to about 2.0 grams of total sugar, natural sweetener, artificial sugar, or any combination thereof based on the total weight of the infusible beverage composition. In some aspects, a sugar, natural sweetener, artificial sugar, or any combination thereof comprising an infusible beverage composition herein may be in one or more composite particles, one or more dehydrated mixtures, or both. In some other aspects, a sugar, natural sweetener, artificial sugar, or any combination thereof comprising an infusible beverage composition herein may not be in one or more composite particles, one or more dehydrated mixtures, or both. In some embodiments, an infusible beverage composition herein can comprise less than about 2.0 grams, less than about 1.75 grams, less than about 1.5 grams, less than about 1.25 grams, less than about 1.0 gram, less than about 0.75 grams, less than about 0.5 grams, or less than about 0.25 grams of total natural sweetener, artificial sugar, or any combination thereof. In some embodiments, an infusible beverage composition herein can contain no sugar, no natural sweetener, no artificial sugar, or any combination thereof.

In certain embodiments, an infusible beverage composition disclosed herein can be packaged into a container. In some embodiments, an infusible beverage composition herein can be packaged into a porous container. In some embodiments, suitable containers for the infusible beverage compositions herein can include infusion packets, cartridges for beverage brewing machines, and the like. In some embodiments, preferred containers for the infusible beverage compositions disclosed herein are infusion packets (e.g., tea bags).

In some embodiments, an infusible beverage composition disclosed herein can be packaged into a mesh packet comprising the infusible beverage compositions disclosed herein. In some embodiments, mesh packets for use herein may have a mesh size ranging from about 10 to about 100. As used herein “mesh size” is defined as the number of openings in one square inch of a screen. Table 1 below details the equivalents to convert from mesh size to micron or vice versa. These measurements indicate the mesh or pore openings in the mesh packets disclosed herein.

TABLE 1

| Micro | U.S. Mesh | Inches |
|---|---|---|
| 2000 | 10 | 0.0787 |
| 1680 | 12 | 0.0661 |
| 1410 | 14 | 0.0555 |
| 1190 | 16 | 0.0469 |
| 1000 | 18 | 0.0394 |
| 841 | 20 | 0.0331 |
| 707 | 25 | 0.028 |
| 595 | 30 | 0.0232 |
| 500 | 35 | 0.0197 |
| 420 | 40 | 0.0165 |
| 354 | 45 | 0.0138 |
| 297 | 50 | 0.0117 |
| 250 | 60 | 0.0098 |
| 210 | 70 | 0.0083 |
| 177 | 80 | 0.007 |
| 149 | 100 | 0.0059 |
| 125 | 120 | 0.0049 |
| 105 | 140 | 0.0041 |
| 88 | 170 | 0.0035 |
| 74 | 200 | 0.0029 |
| 63 | 230 | 0.0024 |
| 53 | 270 | 0.0021 |
| 44 | 325 | 0.0017 |
| 37 | 400 | 0.0015 |

In some embodiments, mesh packets for use herein may have a mesh size of about 10, about 15, about 20, about 25, about 30, about 35, about 40, about 45, about 50, about 55, about 60, about 65, about 70, about 75, about 80, about 85, about 90, about 95, or about 100. In some aspects, mesh packets for use herein may have a mesh size ranging from about 30 to about 50.

In some embodiments, about 50 grams or less of an infusible beverage composition disclosed herein can be packaged into a container (e.g., a mesh packet). In some embodiments, about 1 gram to about 50 grams, about 2 grams to about 45 grams, or about 3 grams to about 40 grams of an infusible beverage composition disclosed herein can be packaged into a container (e.g., a mesh packet). In some embodiments, about 1 gram, about 1.5 grams, about 2 grams, about 2.5 grams, about 3 grams, about 3.5 grams, about 4 grams, about 4.5 grams, about 5 grams, about 5.5 grams, about 6 grams, about 6.5 grams, about 7 grams, about 7.5 grams, about 8 grams, about 8.5 grams, about 9 grams, about 9.5 grams, about 10 grams, about 10.5 grams, about 11 grams, about 11.5 grams, about 12 grams, about 12.5 grams, about 13 grams, about 13.5 grams, about 14 grams, about 14.5 grams, about 15 grams, about 15.5 grams, about 16 grams, about 16.5 grams, about 17 grams, about 17.5 grams, about 18 grams, about 18.5 grams, about 19 grams, about 19.5 grams, or about 20 grams of an infusible beverage composition disclosed herein can be packaged into a container (e.g., a mesh packet).

### II. Methods of Using Infusible Beverage Compositions

The present disclosure provides methods of using the infusible beverage compositions disclosed herein. In some embodiments, methods of using infusible beverage compositions disclosed herein can be used to prepare a cocktail base. In some preferred embodiments, infusible beverage compositions herein packaged in a porous container (e.g., a tea bag, a mesh packet) can be used to prepare a cocktail base.

In some embodiments, a cocktail base can be made by placing any one of the infusible beverage compositions herein in water. In some embodiments, an infusible beverage composition herein can be placed in water, whereby the water can have a temperature ranging from about 5° C. to about 150° C., about 10° C. to about 125° C., or about 15° C. to about 100° C. In some aspects, methods herein can use cold water (e.g., about 24° C. to about 15° C.). In some aspects, methods herein can use room-temperature water (e.g., about 25° C. to about 29° C.). In some aspects, methods herein can use warm water (e.g., about 30° C. to about 53° C.). In some aspects, methods herein can use hot water (e.g., about 54° C. to about 99° C.). In some aspects, methods herein can use water that has a temperature at or above boiling point (e.g., 100° C. and above). In some embodiments, an infusible beverage composition herein can be placed in water, whereby the water may be carbonated water, mineral water, tonic water, soda water, or the like.

In some embodiments, an infusible beverage composition herein can be placed in water until the cocktail base reaches a taste suitable to the consumer (e.g., a human). In some aspects, an infusible beverage composition herein can be placed in water for about 0.5 minutes to about 60 minutes, about 1 minute to about 45 minutes, or about 2 minutes to about 30 minutes. One of skill in the art would appreciate that the duration of time that an infusible beverage composition herein shall be placed in water is based on the type of cocktail base formulation. In some preferred embodiments, an infusible beverage composition herein can be placed in water for about 1 minute to about 10 minutes. In some embodiments, an infusible beverage composition herein can be removed from the water after any time period disclosed in the methods herein. Once the infusible beverage composition is removed from the water, the resulting solution is the cocktail base. In some embodiments, an infusible beverage composition herein can remain in the water during any of the steps described in methods herein. In some embodiments, an infusible beverage composition herein can remain in the cocktail and/or mocktail during consumption of the beverage by the consumer. Where the infusible beverage composition is not removed from the water, the resulting solution after the desired time period is the cocktail base.

In some embodiments, a cocktail base prepared according to the methods herein can be used to make a non-alcoholic beverage. Non-alcoholic infused beverages can interchangeably be referred to as “mocktails” and “virgin cocktails” through the present disclosure. In some embodiments, methods herein of making a mocktail can include preparing the cocktail base. In some other embodiments, methods herein of making a mocktail can include preparing the cocktail base and adding one or more additional liquids, including but not limited to water, sparkling water, mineral water, soda water, tonic, fruit juices and/or concentrates, vegetable juices and/or concentrates, milk, coffee, tea, and the like. In some embodiments, methods herein of making a mocktail can include adding one or more additional liquids during preparation of the cocktail base. In some examples, methods herein of making a mocktail can be adding an infusible beverage composition herein to a mixture of water and one or more additional liquids. In some examples, an infusible beverage composition herein cane remain in the mixture of water and one or more additional liquids as described herein or be removed after a desired period of time to make a mocktail.

In some embodiments, a cocktail base prepared according to the methods herein can be used to make an alcoholic beverage, or a “cocktail.” In some other embodiments, methods herein of making a cocktail can include preparing the cocktail base and adding one or more alcohols. An alcohol (also known as a “spirit”) for use in the cocktails herein is defined herein to be ethanol or other potable alcohol and can be sourced from any consumable alcohol used in making cocktails. Non-limiting examples of alcohols suitable for use herein can include brandy, vodka, gin, rum, tequila, scotch, whiskey, wine, beer, flavored liqueurs (e.g., Anise-flavored liqueurs, Chocolate liqueurs, Coffee liqueurs, Cream liqueurs, Fruit liqueurs, Nut-flavored liqueurs), Pisco, Schnapps, Absinthe, Sake, or any combination thereof. One of skill in the art would appreciate that the total amount of alcohol placed in a cocktail herein is based on the type of cocktail base formulation and/or the amount of alcohol consumption desired by the consumer. In some embodiments, methods herein of making a cocktail can include preparing the cocktail base and adding one or more alcohols wherein the total amount of alcohol is not more than about 80% v/v (which is equivalent to 160 Proof). In some embodiments, methods herein of making a cocktail can include preparing the cocktail base and adding one or more alcohols wherein the total amount of alcohol can be about 5% v/v (10 Proof) to about 80% v/v (160 Proof), about 10% v/v (20 Proof) to about 60% v/v (120 Proof), or about 20% v/v (40 Proof) to about 40% v/v (80 Proof. In some embodiments, methods herein of making a cocktail can include preparing the cocktail base and adding one or more alcohols for a total of about 0.5 oz to about 3 oz, about 1.0 oz to about 2.5 oz, or about 1.5 oz to about 2 oz alcohol per cocktail.

In some embodiments, methods herein of making a cocktail can include adding one or more alcohols as described herein during preparation of the cocktail base. In some examples, methods herein of making a cocktail can be adding an infusible beverage composition herein to a mixture of water and one or more alcohols as described herein. In some examples, an infusible beverage composition herein cane remain in the mixture of water and one or more alcohols as described herein or be removed after a desired period of time to make a cocktail.

### EXAMPLES

The following examples are included to demonstrate preferred embodiments of the disclosure. It should be appreciated by those of skill in the art that the techniques disclosed in the examples that follow represent techniques discovered by the inventors to function well in the practice of the present disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the present disclosure.

### Example 1

In an exemplary method, ingredients for infusible beverages were prepared. In brief, there was a significant lack of homogeneity among ingredients for the infusible beverages disclosed herein. Fine powders and/or granulated ingredients like sugar or erythritol, and larger pieces of diced fruit, herbs and spices were used herein. Because of the differences in size and density, it was impossible to use the raw materials as-is to create a viable product. Challenges would exist both on the customer's end, with powder seepage through the tea bag, and more importantly on the manufacturing end, where the ingredients create dust in the machine as well as significant separation in the blend.

In order to address these issues, a particle processing method called agglomeration was used prior to packing these into our sachets. The goal of this process was to bind particles together, creating a homogenous blend of the powdered and granulated ingredients, as well as increasing average particle size. In brief, agglomeration was performed by adding a recipe blend to a chamber of a Vector FL-M-1 flow coater. The equipment was pre-warmed to 50° C. and continued to operate at that inlet temperature for the duration of the run. Each mixture was fluidized, deionized water and atomized “top-down” into the bed using a two-fluid air atomizing nozzle. Moisture was added to each batch. An analysis of particle size, bulk density and moisture level was then performed to confirm the desired result. Table 2 shows d05 and d10 particle size particle size, bulk density and moisture level for a pre-agglomerated blend of the ingredients for a Ginger Rosemary Mule composition and a Cardamom Paloma composition compared to the agglomerated powder blend.

TABLE 2

| | | Bulk | Mean | d05 | d10 |
|---|---|---|---|---|---|
| | Moisture | density | size | particle | particle |
| | (%) | (g/cc) | (μm) | size | size |
| Ginger Rosemary Mule | 0.577 | 0.755 | 524.2 | 29.4 | 146.9 |
| Ginger Rosemary Mule - | 0.925 | 0.698 | 603.3 | 233.4 | 294.5 |
| agglomerated | | | | | |
| Cardamom Paloma | 0.193 | 0.725 | 481.9 | 153.2 | 248.2 |
| Cardamom Paloma - | 0.244 | 0.750 | 406.3 | 203.0 | 253.5 |
| agglomerated | | | | | |

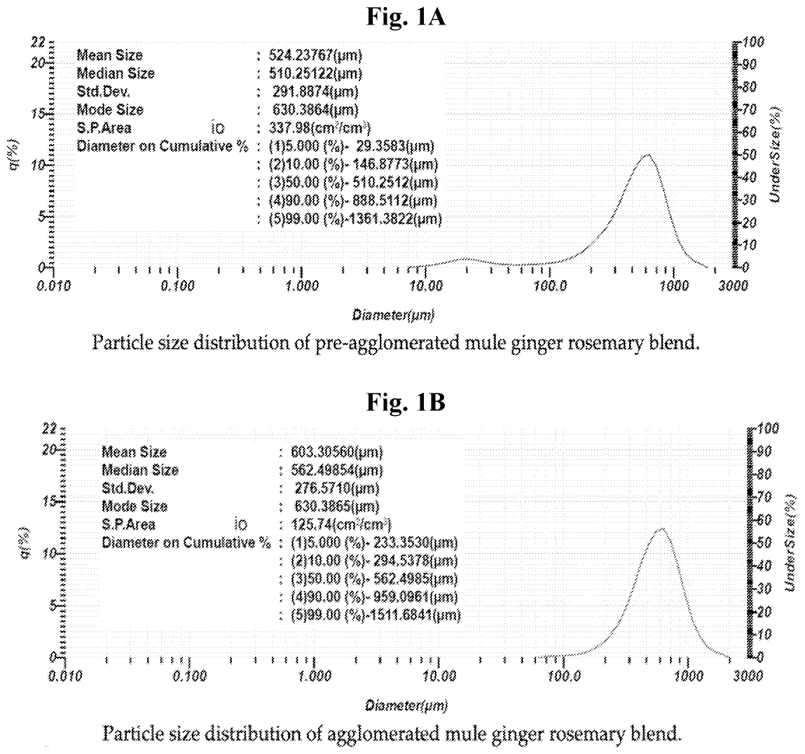

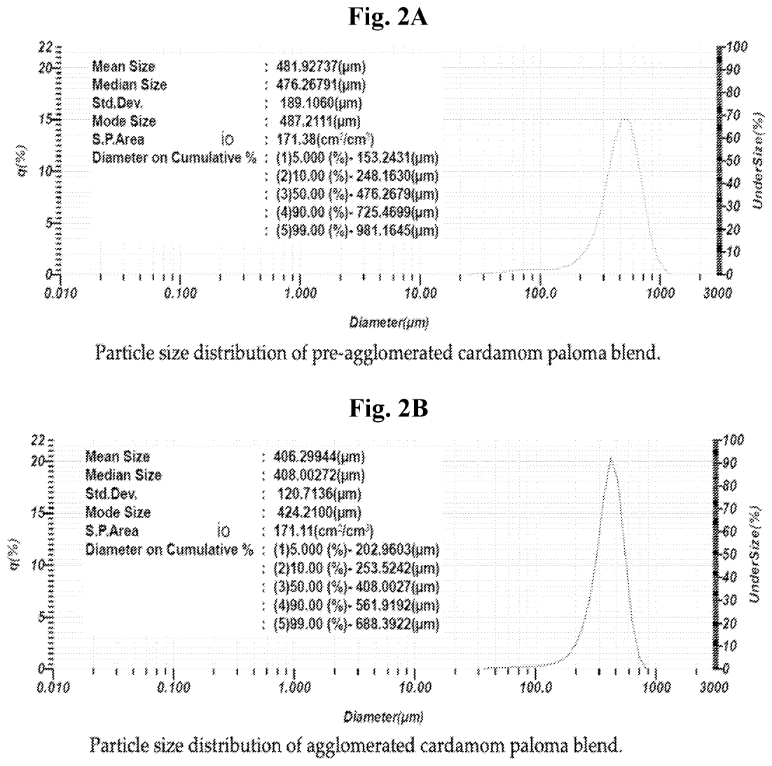

Particle size distribution of a pre-agglomerated blend of ingredients for a Ginger Rosemary Mule composition compared to the agglomerated powder blend are shown in FIGS. 1A-1B. Particle size distribution of a pre-agglomerated blend of ingredients for a Cardamom Paloma composition compared to the agglomerated powder blend are shown in FIGS. 2A-2B.

### Example 2

In an exemplary method, an infusible beverage was prepared. The infusible beverage prepared in this example served as the cocktail base for an Old Fashioned. An Old Fashioned is a known cocktail that is traditionally made by muddling sugar with liquid bitters and water, adding an alcohol of choice (e.g., whiskey or brandy), and garnishing with orange slice or zest and a cocktail cherry.

The cocktail base for an Old Fashioned in this example contained the following ingredients: raw sugar, gentian root powder, cinchona bark, ground clove, crystalized orange granules, and orange rind. All of the ingredients were prepared and packaged together in a porous material, specifically a tea bag. Each tea bag contained: (1) about 85% to about 95% of an agglomerated mix of the raw sugar with the other powdered and granulated ingredients of the cocktail base (e.g., crystalized orange granules) and (2) about 5% to 15% of the dehydrated, whole ingredients of the cocktail base (e.g., cinchona bark, orange rind). Liquid bitters that are traditionally added to cocktails like an Old Fashioned are made from extracts of ingredients like gentian root and cinchona bark. In the cocktail base prepared in this example, a dry, powder version of natural gentian root and pieces of natural cinchona bark was used to provide the same taste as the bitters normally found in an Old Fashioned.

To make the cocktail base, the tea bag was submerged in 0.75 ounces (oz) cold water (generally between 24° C. to 15° C.) or room temperature water (generally between 25° C. to 29° C.). By adding water, the powders and granules were rehydrated to recreate juices or liquid products like bitters or juice, as one would add to a cocktail. The real pieces of fruit, herbs and spices steep and added complexity and nuance to the flavor. As such, a consumer who preferred a cocktail base having a stronger taste would leave the tea bag submerged in the water for longer than 3 minutes. Next, 1.5 oz of an alcoholic spirit (e.g., whiskey or brandy depending on the consumer's preference) was added to the cocktail base to produce an Old Fashion cocktail. Consumers that did not wish to create a cocktail containing an alcoholic spirit instead added 1.5 oz of water to produce an Old Fashion mocktail. The tea bag was submerged in the water and alcohol mixture (or water for a mocktail) for about 3 minutes or until the desired taste was reached by the consumer. For consumers who preferred the taste of a strong cocktail base, the tea bag was submerged for longer than 3 minutes or remained in the cocktail while the cocktail was consumed.

What is claimed is:

1. An infusible beverage composition comprising at least 85% of composite particles and at least 5% of a dehydrated mixture packaged into a porous material,
wherein the composite particles comprise one or more powdered natural food products, one or more granulated natural food products, or a combination thereof; and
the dehydrated mixture comprises one or more dehydrated natural food products,
wherein a natural food product is a fruit, a vegetable, a spice, a herb, an animal product, or any combination thereof.

2. The infusible beverage composition of claim 1, wherein the porous material comprises a tea bag.

3. The infusible beverage composition of claim 1, wherein the composite particles further comprise one or more sugars, artificial sweeteners, natural sweeteners, or a combination thereof.

4. The infusible beverage composition of claim 3, wherein the composite particles comprise one or more sugars, artificial sweeteners, natural sweeteners, or a combination thereof at an amount ranging from less than 0.5% to less than 90% by weight of the composite particle.

5. The infusible beverage composition of claim 3, wherein the composite particles further comprise one or more sugars natural sweeteners.

6. The infusible beverage composition of claim 1, wherein the composite particles do not further comprise one or more sugars, artificial sweeteners, natural sweeteners, or a combination thereof.

7. The infusible beverage composition of claim 1, wherein the composite particles comprise at least 5% one or more powdered natural food products, at least 5% one or more granulated natural food products, or any combination thereof.

8. The infusible beverage composition of claim 1, wherein the dehydrated mixture comprises one or more dried fruit pieces, one or more dried vegetable pieces, or any combination thereof.

9. A beverage comprising a cocktail base, wherein the cocktail base comprises
(i) water; and
(ii) an infusible beverage composition,
the infusible beverage composition comprising at least 85% of composite particles and at least 5% of a dehydrated mixture packaged into a porous material,
wherein the composite particles comprise one or more powdered natural food products, one or more a granulated natural food products, or a combination thereof; and
the dehydrated mixture comprises one or more dehydrated natural food products,
wherein a natural food product is a fruit, a vegetable, a spice, a herb, an animal product, or any combination thereof.

10. The beverage of claim 9, wherein the composite particles further comprise one or more sugars, artificial sweeteners, natural sweeteners, or a combination thereof.

11. The beverage of claim 10, wherein the composite particles comprise one or more sugars, artificial sweeteners, natural sweeteners, or a combination thereof at an amount ranging from less than 0.5% to less than 90% by weight of the composite particle.

12. The beverage of claim 9 further comprising at least one additional liquid, wherein the least one additional liquid is a non-alcoholic liquid, an alcohol, or any combination thereof.

13. The beverage of claim 12, wherein the least one additional liquid comprises an alcohol comprising brandy, vodka, gin, rum, tequila, scotch, whiskey, wine, beer, flavored liqueur, pisco, schnapps, absinthe, sake, or any combination thereof.

14. The beverage of claim 12, wherein the total amount of alcohol is not more than about 80% v/v (160 Proof).

15. A method of preparing an alcoholic beverage comprising:
(i) placing an infusible beverage composition into water; and
(ii) adding at least one alcohol, wherein the alcohol comprises brandy, vodka, gin, rum, tequila, scotch, whiskey, wine, beer, flavored liqueur, pisco, schnapps, absinthe, sake, or any combination thereof,
wherein
the infusible beverage composition comprises at least 85% of composite particles and at least 5% of a dehydrated mixture packaged into a porous material,
wherein the composite particles comprise one or more powdered natural food products, one or more granulated natural food products, or a combination thereof; and
the dehydrated mixture comprises one or more dehydrated natural food products,
wherein a natural food product is a fruit, a vegetable, a spice, a herb, an animal product, or any combination thereof.

16. The method of claim 15, wherein the composite particles further comprise one or more sugars, artificial sweeteners, natural sweeteners, or a combination thereof.

17. The method of claim 16, wherein the composite particles comprise one or more sugars, artificial sweeteners, natural sweeteners, or a combination thereof at an amount ranging from less than 0.5% to less than 90% by weight of the composite particle.

18. The method of claim 15, wherein the infusible beverage composition is removed from the water and the at least one alcohol after a period of time ranging from 1 minute to 60 minutes.

19. The method of claim 15, wherein the infusible beverage composition not is removed from the water and the at least one alcohol.

20. The method of claim 15, wherein the infusible beverage composition is placed into cold water, room-temperature water, warm water, hot water, or water at a temperature at or above boiling point.
